(19) United States
(12) Patent Application Publication
(10) Pub. No.: US 2009/0278505 A1
(43) Pub. Date: Nov. 12, 2009

(54) BATTERY-CONTAINING UNIT AND CHARGING BASE

(76) Inventors: Shoichi TOYA, Minamiawaji City (JP); Yasunari Mizoguchi, Sumoto City (JP); Eiji Satsuma, Sumoto City (JP); Kyozo Terao, Sumoto City (JP)

Correspondence Address: WENDEROTH, LIND & PONACK, L.L.P., 1030 15th Street, N.W.,, Suite 400 East, Washington, DC, 20005-1503, US

(21) Appl. No.: 12/437,761

(22) Filed: May 8, 2009

(30) Foreign Application Priority Data
May 10, 2008 (JP) 2008-124105

(51) Int. Cl. H02J 7/04

(52) U.S. Cl. 320/152; 320/162

(57) ABSTRACT

A battery-containing unit and a charging base are a battery-containing unit includes a lithium ion battery, and a charging base to which the battery-containing unit to be charged is placed. The battery-containing unit includes a charging circuit that converts an alternating current produced in an energized coil into a direct current, and a transmitter that detects the voltage of the lithium ion battery and transmits a voltage signal to the charging base. The charging base includes a receiver that receives the signal from the transmitter and detects the voltage signal, and a high frequency power supply that provides AC power to the energizing coil The power supply of the charging base detects the voltage of the lithium ion battery through the receiver and the transmitter, and is controlled to charge the lithium ion battery so that the voltage of lithium ion battery does not exceed a predetermined voltage.

### BACKGROUND OF THE INVENTION

1. Field of the Invention

The present invention relates to a battery-containing unit and a charging base, the battery-containing unit including a rechargeable battery, and the charging unit charging the battery incorporated in the battery-containing unit.

2. Description of the Related Art

Charging bases have been developed which transmit power from a power supply coil to an induction coil by electromagnetic induction to charge an internal battery (See Japanese Laid-Open Patent Publication No. JP H09-63655 A (1997) and Japanese Utility Model Publication No. JP-U-3011829).

JP H09-63655 A (1997) discloses a structure that includes a charging base having a power supply coil to be energized by a high frequency power supply, and a battery pack having an induction coil inductively connected to the power supply coil. In addition, the battery pack includes a circuit that rectifies an alternating current produced in the induction coil, and supplies the rectified current to a battery to charge the battery. In this structure, when the battery pack is mounted on the charging base, the battery of the battery pack can be charged in a non-contact state.

Also, JP-U-3011829 discloses a structure that includes a battery-containing unit having a battery in its bottom part and a secondary charging adapter under the battery. The secondary charging adapter includes an induction coil and a charging circuit In addition, a structure is also disclosed that includes a charging base having a power supply coil to be inductively connected to the induction coil. When the battery-containing unit is mounted to the charging base to connect the secondary charging adapter to the charging base, power is transmitted from the power supply coil to the induction coil, and the battery of the battery-containing unit will be charged.

### SUMMARY OF THE INVENTION

In the battery-containing unit and the charging base disclosed in the publications, when the battery-containing unit is placed to the charging base, the battery of the battery-containing unit can be charged without requirement of contacts. This type of structure can charge batteries that are charged at a predetermined power rate until being fully charged (e.g., nickel-hydrogen batteries and nickel-cadmium batteries). However, in the case of batteries that are required to be charged at a charging voltage not exceeding a predetermined voltage to prevent danger, a charging current must be gradually decreased when the batteries approach a fully-charged state. If power is transmitted at a constant rate, an invalid magnetic flux generates an eddy current, and heats a case and the like.

The present invention has been developed for solving the disadvantage. It is an Important object of the present invention to provide a battery-containing and a charging base that reduce unnecessary power transmission in a constant-voltage charging range of a lithium ion battery contained in the battery-containing unit to be able to efficiently charge the lithium ion battery.

To achieve the aforementioned object, a battery-containing and a charging base according to the present invention have the following configuration.

The battery-containing unit includes an energized coil and a lithium ion battery to be charged by electric power produced in the energized coil. The charging base that receives the battery-containing unit, and charges the lithium Ion battery of the battery-containing unit. The battery-containing unit includes a charging circuit that rectifies an alternating current produced in the energized coil to convert the alternating current into a direct current for charging the lithium ion battery, and a transmitter that detects the voltage of the lithium ion battery to be charged and transmits a voltage signal to the charging base. The charging base includes a receiver that receives signals transmitted from the transmitter of the battery-containing unit and detects the voltage signal of the lithium ion battery, and a high frequency power supply that is controlled based on the voltage signal detected by the receiver to provide AC power to the energizing coil whereby charging the lithium ion battery at a voltage not greater than a predetermined voltage. The high frequency power supply of the charging base detects the voltage of the lithium ion battery to be charged through the receiver and the transmitter, and is controlled based on the detected voltage to charge the lithium ion battery so that the voltage of lithium ion battery does not exceed the predetermined voltage.

According to the aforementioned configuration, when the lithium ion battery approaches a fully-charged state, the lithium ion battery can be fully charged so that power is reduced that is provided from the charging base to the battery-containing unit. Accordingly, the lithium ion battery can be fully charged at high efficiency by power provided from the charging base to the battery-containing unit. The reason is that the charging base controls power provided to the battery-containing unit, and charges the lithium ion battery. For this reason, the battery-containing unit does not waste power to control power for charging the lithium ion battery, and it is possible to reduce heat generated by an eddy current in a battery case of the battery-containing unit. Heat generated in the battery-containing unit may adversely affect the lithium ion battery. According to the present invention, since heat generated in the battery-containing unit can be reduced by control of charging power by the charging base side, it is possible to suppress a temperature rise of the lithium ion battery.

In addition, in the battery-containing and the charging base according to the present invention, the transmitter of the battery-containing unit can include a modulating circuit that modulates carrier waves according to the voltage of the lithium ion battery and a transmitting antenna that wirelessly transmits a signal modulated by the modulating circuit by radio waves, and the receiver of the charging base can include a receiving antenna that receives the radio waves wirelessly transmitted from the transmitter and a receiving circuit that demodulates the signal received by the receiving antenna to detect the voltage signal.

According to this configuration, since the voltage signal of the lithium ion battery is transmitted to the charging base by radio waves that are transmitted from the transmitting antenna to the receiving antenna, power can be transmitted from the charging base to the battery-containing unit to charge the lithium ion battery without an influence on power transmission from the energizing coil to the energized coil.

In addition, in the battery-containing and the charging base according to the present invention, the transmitter of the battery-containing unit can transmit the voltage signal of the lithium ion battery to the charging base through the energized coil and the energizing coil.

According to this configuration, the voltage signal of the lithium ion battery can be transmitted from the battery-containing unit to the charging base without antennas. Accordingly, the voltage signal of the lithium ion battery can be stably transmitted from the battery-containing unit to the charging base by a simple circuit structure.

In addition, in the battery-containing and the charging base according to the present invention, the transmitter of the battery-containing unit can include a switching element that controls ON/OFF switching timing based on the voltage signal of the lithium ion battery and is connected to the output side of the energized coil, and the load impedance of the energized coil can be controlled by the ON/OFF switching of the switching element so that the voltage signal of the lithium ion battery is transmitted to the charging base.

According to this configuration, the voltage signal of the lithium ion battery can be stably transmitted to the charging base even by a simple circuit structure in that the switching element is provided in the transmitter to be turned ON/OFF.

In addition, in the battery-containing and the charging base according to the present invention, the transmitter can include a control circuit that controls, based on the voltage signal of the lithium ion battery, a switching-ON period of the switching element or an ON state time width of the switching element.

According to this configuration, since a period or a time width of the switching element represents the voltage signal of the lithium ion battery to be transmitted, the voltage signal of the lithium ion battery can be stably transmitted to the charging base by a simple circuit structure.

In addition, in the battery-containing and the charging base according to the present invention, the battery-containing unit can include an impedance element that is serially connected to the switching element, and a serial connection circuit of the switching element and the impedance element can be connected to the energized coil.

According to this configuration, the voltage signal of the lithium ion battery can be stably transmitted to the charging base by grounding the output side of the energized coil via the impedance element and varying the load impedance of the energized coil at predetermined timing.

In addition, in the battery-containing and the charging base according to the present invention, the impedance element can be a capacitor.

According to this configuration, the voltage signal of the lithium ion battery can be stably transmitted to the charging base by grounding the load of the energized coil via a capacitor that is alternately grounded.

In addition, in the battery-containing and the charging base according to the present invention, the transmitter can include a modulating circuit that modulates carrier waves according to the voltage of the lithium ion battery, the carrier waves that are modulated by the modulating circuit being provided to the energized coil, and the receiver of the charging base can include a receiving circuit that demodulates the carrier waves transmitted from the energized coil to the energizing coil and detects the voltage signal.

According to this configuration, the voltage signal of the lithium ion battery can be stably transmitted to the charging base through radio waves.

In addition, in the battery-containing and the charging base according to the present invention, battery-containing unit can include a detachable battery pack, and the battery pack can include the lithium ion battery, a shield film that shields the lithium ion battery from an AC magnetic field of the energizing coil, the charging circuit for the lithium ion battery, and the transmitter that transmits the voltage signal of the lithium ion battery to the charging base.

According to this configuration, the lithium ion battery of the battery pack can be fully charged so that heat is reduced that is generated in the battery pack. In the case of the battery-containing unit that includes the detachable battery pack, it is more difficult to dissipate heat in the battery pack. The reason is that the battery pack is configured small to be mounted to the battery-containing unit. Since a lithium ion battery and a charging circuit contained in battery-containing units can have a heat dissipation area relatively larger than those contained in a battery pack, as compared with the case of battery packs, heat can be easily dissipated in the lithium ion battery and the charging circuit contained in the battery-containing units. Contrary to this, battery packs are configured very small to be mounted to the battery-containing units. Accordingly, battery packs cannot have a large heat dissipation area. For this reason, it is very important for battery packs to reduce heat generation. According to the aforementioned battery-containing and charging base, the lithium ion battery of the battery pack can be fully charged so that heat is reduced that is generated in the battery pack. In particular, the lithium ion battery can be fully charged with being magnetically shielded from an alternating current magnetic field of the energizing coil by the shield film. In addition, when the lithium ion battery approaches a fully-charged state, power is reduced that is provided from the charging base to the battery-containing unit. Accordingly, the lithium ion battery can be fully charged to reduce heat generated in the shield film, and heat generated in the lithium ion battery and the circuit board that are magnetically shielded by the shield film.

The above and further objects of the present invention as well as the features thereof will become more apparent from the following detailed description to be made in conjunction with the accompanying drawings.

### BRIEF DESCRIPTION OF THE DRAWINGS

FIG. 1 is a schematic view showing a battery-containing unit and a charging base according to one embodiment of the present invention;

FIG. 2 is a block diagram showing a battery-containing unit and a charging base according to a first embodiment of the present invention;

FIG. 3 is a block diagram showing a battery-containing unit and a charging base according to a second embodiment of the present invention;

FIG. 4 is a block diagram showing a battery-containing unit and a charging base according to a third embodiment of the present invention;

FIG. 5 is a view showing the state where a transmitter shown in FIG. 4 turns a switching the switching element ON/OFF according to a voltage signal, a current signal, and a temperature signal;

FIG. 6 is an exploded perspective view showing a battery-containing unit with a battery pack being detached from a battery-containing unit;

FIG. 7 is an exploded perspective view of the battery pack shown in FIG. 6;

FIG. 8 is a horizontal cross-sectional view showing the internal structure of the charging base shown in FIG. 1;

FIG. 9 is a longitudinal vertical cross-sectional view of the charging base shown in FIG. 8;

FIG. 10 is a traverse vertical cross-sectional view of the charging base shown in FIG. 8;

FIG. 11 is a circuit diagram showing a position detecting controller of a charging base;

FIG. 12 is a diagram showing an exemplary echo signal that is provided from an energized coil energized by a pulse signal;

FIG. 13 is a diagram showing variation of oscillation frequency in relation to positional deviation between an energizing coil and an energized coil;

FIG. 14 is a circuit diagram showing another exemplary position detecting controller of a charging base; and

FIG. 15 is a diagram showing levels of echo signals produced in a position detecting coils of the position detecting controller shown in FIG. 14.

### DETAILED DESCRIPTION OF THE EMBODIMENT(S)

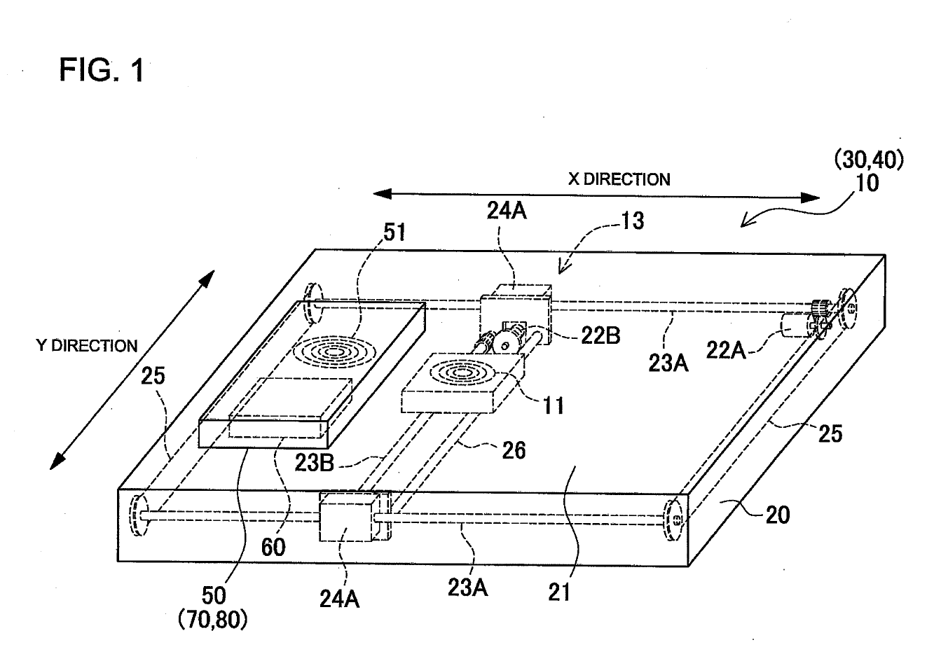

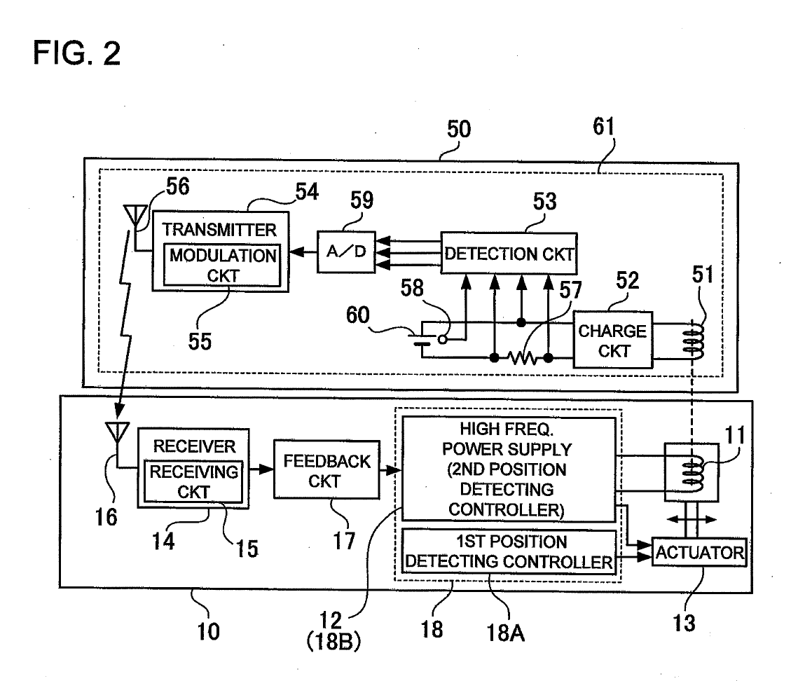

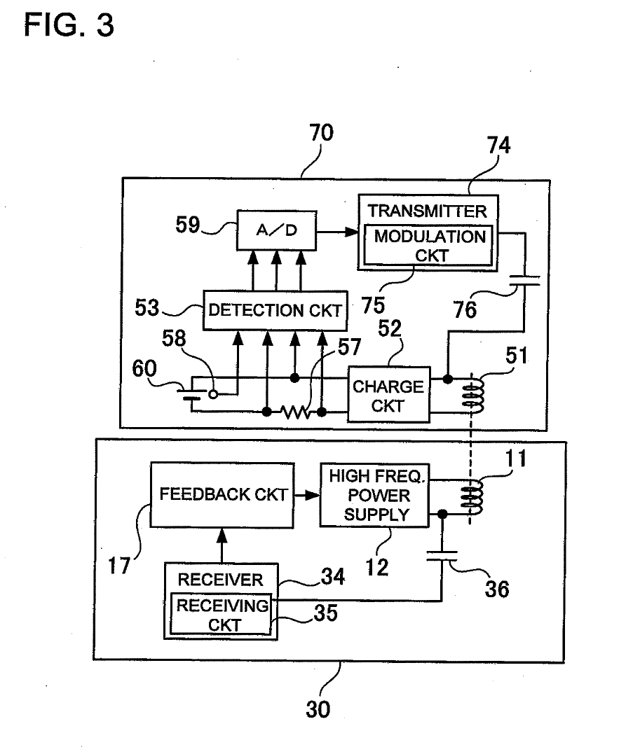

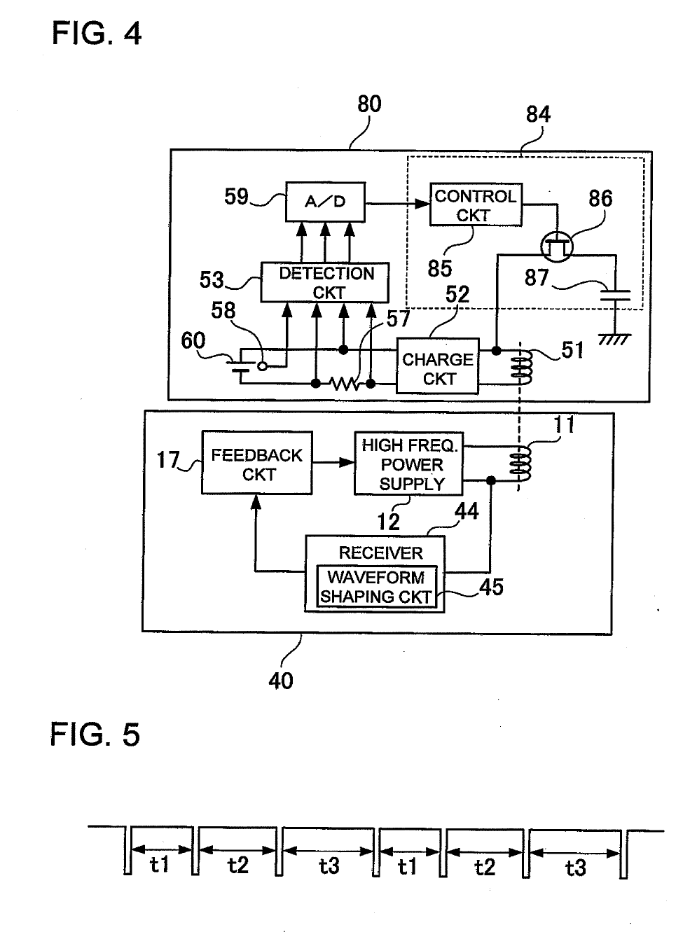

FIG. 1 shows a battery-containing unit 50 (70, 80) that includes a lithium ion battery 60 as a power supply, and a charging base 10 (30, 40) that receives the battery-containing unit 50 (70, 80) and charges the lithium ion battery 60 contained in the battery-containing unit 50 (70, 80). FIG. 2 is a block diagram showing the battery-containing unit 50 and the charging base 10 according to a first embodiment of the present invention. FIG. 3 is a block diagram showing the battery-containing unit 70 and the charging base 30 according to a second embodiment of the present invention. FIG. 4 is a block diagram showing the battery-containing unit 80 and the charging base 40 according to a third embodiment of the present invention.

The battery-containing unit 50 (70, 80) includes an energized coil 51 that is inductively connected to an energizing coil 11 of the charging base 10 (30, 40), a charging circuit 52 that rectifies an alternating current produced in the energized coil 51 to convert the alternating current into a direct current for charging the lithium ion battery 60, a detecting circuit 53 that detects the voltage, current and temperature of the lithium ion battery 60 to be charged, and a transmitter 54 (74, 84) that transmits voltage, current signal and temperature signals detected by the detecting circuit 53 to the charging base 10 (30, 40).

Although not illustrated, the charging circuit 52 includes a rectifying circuit that rectifies the alternating current produced in the energized coil 51 and converts the alternating current into a direct current, and a smoothing circuit that is composed of a capacitor for smoothing a fluctuating current flow rectified in the rectifying circuit. The lithium ion battery 60 is fully charged with voltage and current being controlled. However, the charging circuit 52 does not detect the voltage and current of the lithium ion battery 60 to be charged, and does not control the charged state of the lithium ion battery 60 by controlling voltage and current. The charging voltage and the charging current of the lithium ion battery 60 are controlled by a high frequency power supply 12 of the charging base 10 (30, 40).

In order that the high frequency power supply 12 of the charging base 10 (30, 40) may control charging operation for the lithium ion battery 60, the battery-containing unit 50 (70, 80) includes the transmitter 54, (74, 84) that transmits the state of the lithium ion battery 60 to the charging base 10 (30, 40). The transmitter 54 (74, 84) transmits the voltage, current signal and temperature signals detected by the detecting circuit 53 to a receiver 14 (34, 44) of the charging base 10 (30, 40).

The detecting circuit 53 detects the voltage, current and temperature of the lithium ion battery 60. The circuit for detecting the current amplifies the voltage at the both ends of a current detection resistor 57 that is serially connected to the lithium ion battery 60 by means of an amplifier (not shown). The charging current is detected based on the output voltage of the amplifier. In order to detect the temperature of the lithium ion battery 60, a temperature sensor 58 is provided that is thermally coupled to the lithium ion battery 60. The temperature sensor 58 detects the battery temperature by detecting the resistance of an element the resistance of which varies according to temperature (e.g., thermistor). The voltage current, and temperature of the lithium ion battery 60 are converted into digital signals by an A/D converter 59. The A/D converter 59 cyclically converts the voltage, current and temperature into digital signals one after another at a predetermined sampling period, and provides the voltage, current and temperature signals to the transmitter 54 (74, 84).

The charging base 10 (30, 40) includes the receiver 14 (34, 44) that receives signals transmitted from the transmitter 54 (74, 84) of the battery-containing unit 50 (70, 80) and detects the voltage, current and temperature signals of the lithium ion battery 60, and the high frequency power supply 12 that is controlled based on the voltage, current and temperature signals detected by the receiver 14 (34, 44) to provide AC power to the energizing coil 11 whereby charging the lithium ion battery 60 at a voltage not greater than a predetermined voltage.

The high frequency power supply 12 Is controlled through a feedback circuit 17 based on the voltage, current and temperature signals that are detected by the receiver 14. The feedback circuit 17 controls the output of the high frequency power supply 12 so that the lithium ion battery 60 is charged at a constant voltage and a constant current. Accordingly, the feedback circuit 17 controls the output of the high frequency power supply 12 so that the detected voltage of the lithium ion battery 60 does not exceed a preset value. For example, when the voltage of the charged lithium ion battery 60 becomes higher than the preset value, the feedback circuit 17 controls the high frequency power supply 12 so that the output of the high frequency power supply 12 is reduced to reduce the voltage of the lithium ion battery 60. Also, when the voltage of the lithium ion battery 60 becomes lower than the preset value, the feedback circuit 17 controls the high frequency power supply 12 to increase the output of the high frequency power supply 12 so that the voltage of the lithium ion battery 60 is controlled to the preset value. In addition, the feedback circuit 17 also controls the charging current of the lithium ion battery 60. The lithium ion battery 60 is charged at a constant current in the case where the voltage is lower than the preset value. In this case, if the charging current is smaller than a preset value, the feedback circuit 17 controls the high frequency power supply 12 to increase the output of the high frequency power supply 12 so that the charging current is brought to the preset value. Contrary to this, if the charging current is greater than the preset value, the feedback circuit controls the high frequency power supply to reduce the charging current, so that the charging current is brought to the preset value. In addition, the feedback circuit 17 also controls the charging current according to the temperature of the lithium ion battery 60. If the battery temperature becomes higher than a maximum limit temperature or becomes lower than a minimum limit temperature, the charging current Is reduced or the charging current is cut off.

The high frequency power supply 12 is a DC/DC converter that controls duty, though not illustrated, in that a switching element serially connected to a high frequency transformer is turned ON/OFF. Thus, the high frequency power supply 12 can control its output. When the switching element is turned ON at a longer period, in other words, when the duty is greater, the output of the high frequency power supply can be increased, conversely, when the duty is smaller, the output can be reduced.

The following description will describe the transmitter of the battery-containing unit and the receiver of the charging base according to the first to third embodiments with reference to FIGS. 2 through 4.

The transmitter 54 of said battery-containing unit 50 includes a modulating circuit 55 that modulates carrier waves according to the voltage, current and temperature signals, and a transmitting antenna 56 that wirelessly transmits signals modulated by the modulating circuit 55 by radio waves. The transmitter 54 modulates the carrier waves by means of the modulating circuit 55, and wirelessly transmits the carrier waves from the transmitting antenna 56 by radio waves. The transmitter 54 wirelessly transmits the carrier waves according to the voltage, current and temperature signals cyclically provided one after another from the detecting circuit 53 from the transmitting antenna 56 by radio waves. For example, the frequency of the carrier waves can be several MHz to several GHz. The transmitting antenna 56 of the transmitter 54 is located in proximity to the energized coil 51,

The receiver 14 of the charging base 10 shown in FIG. 2 includes a receiving antenna 16 that receives the radio waves wirelessly transmitted from the transmitter 54, and a receiving circuit 15 that demodulates the signals received by the receiving antenna 16 to detect the voltage, current and temperature signals. Although not illustrated, the receiving circuit 15 includes a tuning circuit that selectively receives the carrier waves of the transmitter 54 from the signals received by the receiving antenna 16, and a demodulating circuit that demodulates the carrier waves selectively received by the tuning and detects the voltage, current and temperature signals. The receiving circuit 15 selectively detects the carrier waves by means of the tuning circuit, and demodulates the detected carrier waves by means of the demodulating circuit to detect the voltage, current, and temperature of the lithium ion battery 60. The detected voltage, current and temperature signals are provided to the feedback circuit 17. The feedback circuit 17 controls the high frequency power supply 12 based on the provided signals, and controls the charging voltage and current of the lithium ion battery 60 to charge the lithium ion battery 60 at a constant voltage and a constant current.

The battery-containing unit 50 and the charging base 10 shown in FIG. 2 transmit the radio waves from the transmitting antenna 56 to the receiving antenna 16 to transmit the voltage signal of the lithium ion battery to the charging base. According to this configuration, power can be transmitted from the charging base 10 to the battery-containing unit 50 to charge the lithium ion battery 60 without an influence on power transmission from the energizing coil 11 to the energized coil 51. In the battery-containing unit 50 and charging base 10, although not illustrated, preferably, the transmitting antenna 56 of the transmitter 54 is located in proximity to the energized coil 51, and the receiving antenna 16 of the receiver 14 is located in proximity to the energizing coil 11. According to this structure, since, when the energizing coil 11 is located in proximity to the energized coil 51 to charge the lithium ion battery 60, the receiving antenna 16 and the transmitting antenna 56 can be located in proximity to each other, it is possible to reliably transmit the radio waves from the transmitter 54 the receiver 14 to transmit the signals.

The battery-containing units 70 and 80 and the charging bases 30 and 40 shown in FIGS. 3 and 4 wirelessly transmit the voltage, current and temperature signals of the lithium ion battery 60 not by the wireless transmission that modulates carrier waves, in other words, without using the transmitting antenna and the receiving antenna.

The battery-containing unit 70 and the charging base 30 shown in FIG. 3 transmit the carrier waves from the transmitter 74 to the receiver 34 through the energized coil 51 and the energizing coil 11 without using the transmitting antenna and the receiving antenna. The transmitter 74 provides high frequency output to the energized coil 51 through a coupling capacitor 76. The transmitter 54 includes a modulating circuit 75 that modulates the carrier waves according to the voltage, current and temperature of the lithium ion battery 60. The carrier waves modulated by the modulating circuit 75 are provided to the energized coil 51. In this transmitter 74, the frequency of the carrier waves modulated by the modulating circuit 75 can be several hundreds MHz to several GHz, which are higher than the frequency of power transmission from the energizing coil 11 to the energized coil 51 to charge the lithium ion battery 60.

The receiver 30 includes a receiving circuit 35 that demodulates the carrier waves transmitted from the energized coil 51 to the energizing coil 11, and detects the voltage, current and temperature signals. High frequency output produced in the energizing coil 11 is provided to the receiving circuit 35 of the receiver 34 via a coupling capacitor 36. Although not illustrated, the receiving circuit 35 includes a tuning circuit that selectively receives the carrier waves from the provided signals, and a demodulating circuit that demodulates the carrier waves selectively received by the tuning circuit and detects the voltage, current and temperature signals. The receiving circuit 35 selectively detects the carrier waves by means of the tuning circuit, and demodulates the detected carrier waves by means of the demodulating circuit to detect the voltage, current, and temperature of the lithium ion battery 60. The detected voltage, current and temperature signals are provided to the feedback circuit 17. The feedback circuit 17 controls the high frequency power supply 12 based on the provided signals, and control the charging voltage and current of the lithium ion battery 60 to charge the lithium ion battery 60 at a constant voltage and a constant current.

The transmitter 84 of the battery-containing unit 80 shown in FIG. 4 includes a switching element 86 that is connected to the output side of the energized coil 51. The ON/OFF switching timing of the switching element 86 is controlled based on the voltage, current and temperature signals of the lithium ion battery 60 so that the load impedance of the energized coil 51 is controlled. When the switching element 86 is turned ON, the output side of the energized coil 51 is grounded so that the load impedance becomes small. As shown in FIG. 4, an impedance element 87 of a capacitor is serially connected to the switching element 86. The capacitor has small impedance for an alternating current. Accordingly, when the switching element 86 is turned ON, the impedance of the energized coil 51 on the output side becomes small, that is, the output side of the energized coil 51 is nearly short-circuited. The illustrated transmitter 84 includes a control circuit 85 that controls switching-ON periods (t) of the switching element 86 based on the voltage, current and temperature signals of the lithium ion battery 60. The control circuit 85 controls the switching-ON periods (t) of the switching element 86 based on the voltage, current and temperature signals of the lithium ion battery 60 one after another. The transmitter 84 transmits the voltage, current and temperature of the lithium ion battery 60 to the charging base 40 through the energized coil 51 and the energizing coil 11.

In the case of FIG. 4, although the capacitor as the impedance element 87 is serially connected to the switching element 86. Instead of the capacitor, the impedance element may be a resistor with low resistance or an element with smaller impedance for an alternating current such as a coil with smaller inductance as compared with the energized coil.

As shown in FIG. 5, the control circuit 85 changes a switching-ON period (t1) of the switching element 86 based on the voltage signal provided to the control circuit 85, and transmits the voltage signal to the charging base 40. For example, the voltage signal is transmitted so that the period (t1) is longer if a voltage value of the voltage signal becomes large, and is transmitted so that the period (t1) is shorter if the voltage value becomes small. Also, the control circuit 85 changes a switching-ON period (t2) of the switching element 86 based on the current signal provided to the control circuit 85, and transmits the current signal to the charging base 40. For example, the current signal is transmitted so that the period (t2) is longer if a current value of the current signal becomes large, and is transmitted so that the period (t2) is shorter if the current value becomes small. Also, the control circuit 85 changes a switching-ON period (t3) of the switching element 86 based on the temperature signal provided to the control circuit 85, and transmits the temperature signal to the charging base 40. For example, the temperature signal is transmitted so that the period (t3) is longer if a temperature value of the temperature signal becomes large, and is transmitted so that the period (t3) is shorter if the temperature value becomes small. It should be appreciated that the control circuit can control an ON state time width of the switching element according to the voltage, current and temperature signals provided to the control circuit.

The receiver 44 of the charging base 40 detects the change of the load impedance of the energized coil 51 based on waveform shaping. When the switching element 86 is turned ON/OFF, the waveform of a high frequency signal changes that is produced in the energizing coil 11. The receiver 44 shapes the waveform in the energizing coil 11 by means of a waveform shaping circuit 45, and detects the variation of the impedance of the energized coil 51. The waveform shaping circuit 45 provides a trigger signal that is synchronized with switching-ON timing of the switching element 86 of the transmitter 84. The receiver 44 detects the voltage, current and temperature of the lithium ion battery 60 based on the periods (t1, t2, t3) of the trigger signals. The feedback circuit 17 is provided with the voltage, current and temperature signals of the lithium ion battery 60 that are detected by the receiver 44. The feedback circuit 17 controls the high frequency power supply 12 based on the provided voltage, current and temperature signals to charge the lithium ion battery 60 at a constant voltage and a constant current.

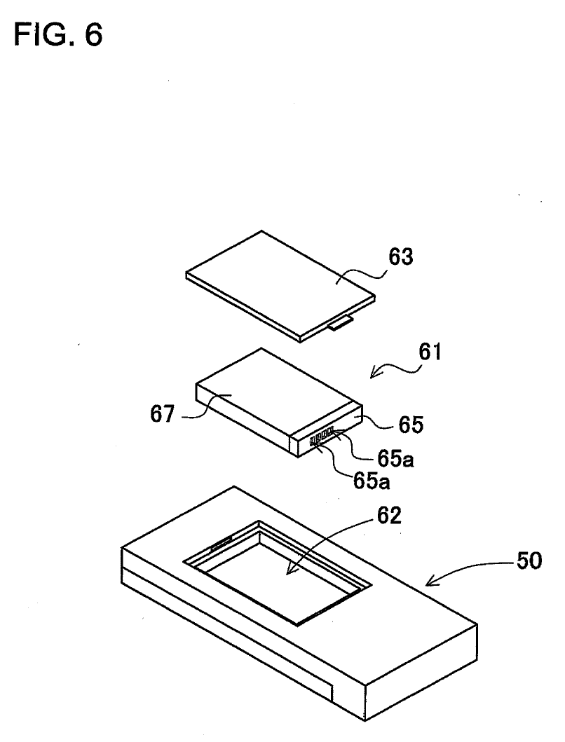

A battery pack 61 is detachably attached to a battery accommodating portion 62 of the battery-containing unit 50 shown In FIG. 6. The battery pack 61 includes the lithium ion battery 60. The battery-containing unit 50 shown in FIG. 6 has the battery accommodating portion 62 that is formed in a shape capable of accommodating the purpose-built battery pack 61. The battery pack 61 is detachably attached to this battery accommodating portion. After a detachable lid 63 is detached, the battery pack 61 shown in FIG. 6 can be attached to the battery accommodating portion 62. The illustrated battery pack 61 has the separately-configured detachable lid 63. It should be appreciated that the battery pack attached to the battery accommodating portion can have an integrally-configured movable lid. This battery pack is accommodated in the battery accommodating portion, and an opening of the battery accommodating portion is then closed.

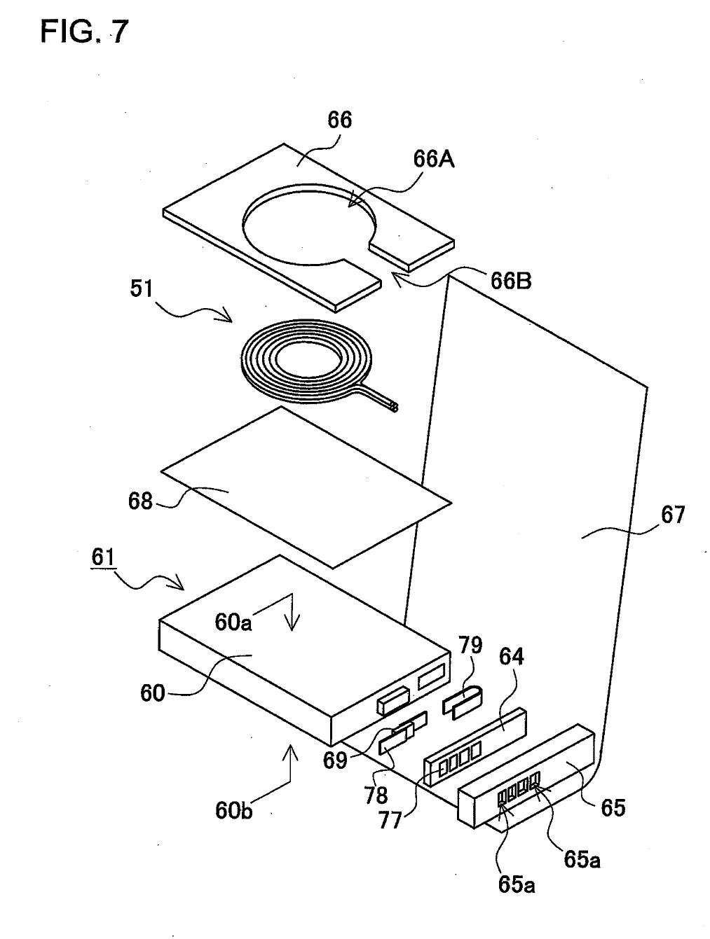

As shown in FIG. 2 and FIG. 7, the battery pack 61 detachably attached to the battery-containing unit 50 includes the lithium ion battery 60 that serves as a power supply for the battery-containing unit 50, the charging circuit 52 that charges the lithium ion battery 60, the energized coil 51 that provides power to the charging circuit 52, a shield film 68 that shields the lithium ion battery 60 from an AC magnetic field of the energizing coil 11, the detecting circuit 53 that detects the voltage, current and temperature of the lithium ion battery 60 to be charged, and the transmitter 54 that transmits the voltage, current and temperature of the lithium ion battery 60 detected by the detecting circuit 53 to the charging base 10.

However, the battery-containing unit may not have the detachable battery pack. In this case, a non-detachable, rechargeable lithium ion battery can be contained In the battery-containing unit, and the charging circuit for the lithium Ion battery, the detecting circuit and the transmitter can be also contained in the battery-containing unit. Alternatively, the battery-containing unit may have a detachable battery pack that includes only the lithium ion battery, and the charging circuit for the lithium ion battery, the detecting circuit and the transmitter may be non-detachably configured and contained in the battery-containing unit. In the case where the battery-containing unit itself includes the contained charging circuit, and the detachable battery pack of the battery-containing unit includes the lithium ion battery, the charging circuit and the battery pack are connected to each other via their contacts so that the lithium ion battery is charged with power produced in the energized coil.

The battery pack 61 shown in FIG. 7 includes the lithium ion battery 60 of a thin battery, a circuit board 64, and a cover case 65 that covers and positions the circuit board 64 at a predetermined position. In the illustrated battery pack 61, the shield film 68 is laminated on the surface of the lithium ion battery 60, and the energized coil 51 and a spacer 66 are arranged on the shield film. A plastic film 67 is adhered onto the entire outside of them to hold them in place.

The lithium ion battery 60 shown in FIG. 7 is a thin battery that has a width wider than a thickness, and has first and second flat surfaces 60a and 60b of two opposed surfaces. The first and second flat surfaces 60a and 60b have a rectangular shape.

Although not illustrated, the circuit board 64 includes on-board electronic components that realize the detecting circuit for detecting the voltage, current and temperature of the lithium ion battery 60, and on-board electronic components that realize the transmitter for transmitting the voltage, current and temperature of the lithium ion battery 60 detected by the detecting circuit to the charging base. Although not illustrated, the circuit board 64 includes an on-board protection circuit for the lithium Ion battery 60. The protection circuit is a circuit that protects the lithium ion battery 60 from an over-current, or a circuit that prevents the lithium ion battery 60 from being over-charged and over-discharged. In the battery pack 61 shown FIG. 7, the circuit board 64 is connected to positive/negative terminals of the lithium ion battery 60 via lead plates 78 and 79. In the illustrated battery pack 61, one connecting lead is composed of a protection element 69 and is connected to a protruding terminal arranged on an electrode terminal surface of the lithium ion battery 60 via the lead plate 78, and the lead plate 79 as the other connecting lead is connected to a flat terminal arranged on an electrode terminal surface of the lithium ion battery 60. The cover case 65 is coupled so that the circuit board 64 is positioned at a predetermined position with being connected to the lithium ion battery 60. The output terminals 77 are fastened onto the surface of the circuit board 64. The output terminals 77 are externally exposed through electrode windows 65a that are arranged in the cover case 65. The cover case 65 is formed of an insulating material such as plastic, and is coupled onto a battery end surface on which the circuit board 64 is arranged.

The energized coil 51 is a flat coil composed of wire lines that are spirally coiled on a plane. The flat coil of the energized coil 51 is a coreless coil. The energized coil 51 of the flat coil is arranged and secured above the first flat surface 60a of the thin battery to interpose the shield film 68 between them. When the battery pack 61 is placed to the battery-containing unit 50, the energized coil 51 is located inside the detachable lid 63 as a back surface plate, and is arranged in proximity to and in parallel to the back surface plate. The energized coil 51 is composed of a plurality of insulated metal lines that are spirally coiled in parallel to the first flat surface 60a of the lithium ion battery 60 of the thin battery to compose the coreless, flat coil.

In the case of the battery-containing unit that charges the lithium ion battery 60 by magnetic induction of the energized coil 51, if an eddy current caused by the magnetic induction flows in an exterior can of the lithium ion battery 60, adverse effects such as heat generation in the exterior can may arise. In order to prevent such adverse effects, the shield film 68 is arranged between the energized coil 51 and the first flat surface 60a of the lithium ion battery 60.

The shield film 68 magnetically shields the lithium ion battery 60 from magnetic flux from the energizing coil 11 to prevent adverse effects on the lithium ion battery 60. The shield film 68 is formed in a sheet shape, and is formed of a high-permeability material such as amorphous metal to shield the magnetic flux from the energizing coil 11. The sheet-shaped shield film 68 is laminated on the first flat surface 60a of the lithium ion battery 60 of the thin battery, and the energized coil 51 is arranged on the shield film 68. The shield film 68 has a shape that covers the first flat surface 60a, in other words, a rectangular shape same as the first flat surface 60a. The shield film 68 covers the entire surface of or the substantially entire surface of the first flat surface 60a.

According to the configuration in that the energized coil 51 is thus arranged above the lithium ion battery 60 to interpose the shield film 68 between them, it is possible to effectively prevent effects caused by magnetic flux, such as adverse effects of heat generation caused by an eddy current produced in the exterior can of the lithium ion battery 60 and the like. In addition to this, since the lithium ion battery 60 does not affect the magnetic flux flowing from the energizing coil 11, there is a feature in that power can be transmitted from the energizing coil 11 to the energized coil 51 at higher efficiency.

The spacer 66 is formed in a sheet shape or a plate shape to be laminated onto the first flat surface 60a, and has a rectangular shape same as the first flat surface 60a. The spacer 66 shown in FIG. 7 has a fit-in opening 66A that is located in the central part of the spacer 66 and penetrates from one surface to the other surface of the spacer 66 to receive the energized coil 51. The energized coil 51 is accommodated in, in other words, is fitted in the fit-in opening 66A to be positioned at a predetermined position. For this reason, in order to accommodate the energized coil 51, the fit-in opening 66A has an exterior shape that is slightly larger than the exterior shape of the energized coil 51, for example, 0.2 to 1 mm larger than the exterior shape of the energized coil 51. The spacer 66 shown in FIG. 7 has a drawing-out portion 66B that is formed by cutting off a part of the fit-in opening 66A so that lead lines of the energized coil 51 are drawn out. The energized coil 51 of the spirally-coiled flat coil has two lead lines in the central part and on the peripheral part. In order to draw out the lead lines from the flat coil, the spacer 66 has the drawing-out portion 66B. The lead lines of the energized coil 51 are drawn pulled out from the drawing-out portion 66B, and is connected to the circuit board 64. The thickness of the spacer 66 is same as the thickness of the energized coil 51. When the fit-in opening 66A of this spacer 66 accommodates the energized coil 51, the exterior surface of the energized coil 51 can be coplanar with the exterior surface of the spacer 66.

The plastic film 67 is a flexible insulating sheet or label formed of plastic. The plastic film 67 is adhered onto the lithium ion battery 60 and the cover case 65 by an adhesive or an adhesive layer. The plastic film 67 is adhered on the first and second flat surfaces 60a and 60b, and the both side surfaces of the lithium ion battery 60 of the thin battery. The aforementioned battery pack is assembled by covering the outer peripheral surfaces by the plastic film 67. It should be appreciated that the battery pack may include a frame case that covers the outer periphery of the battery. This type of frame case can be formed of plastic to be integrally formed with the whole battery.

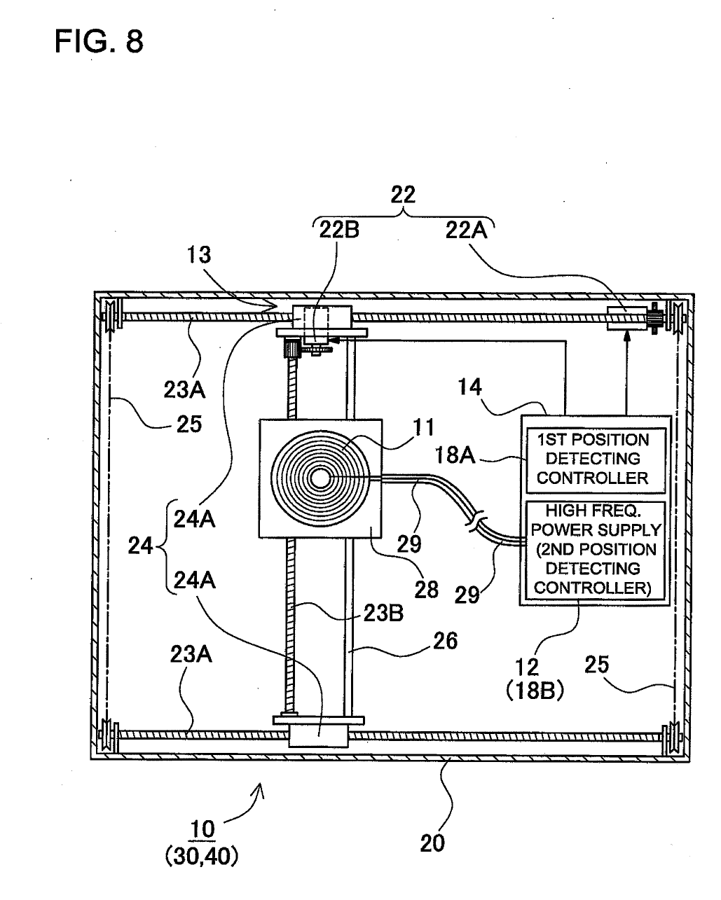

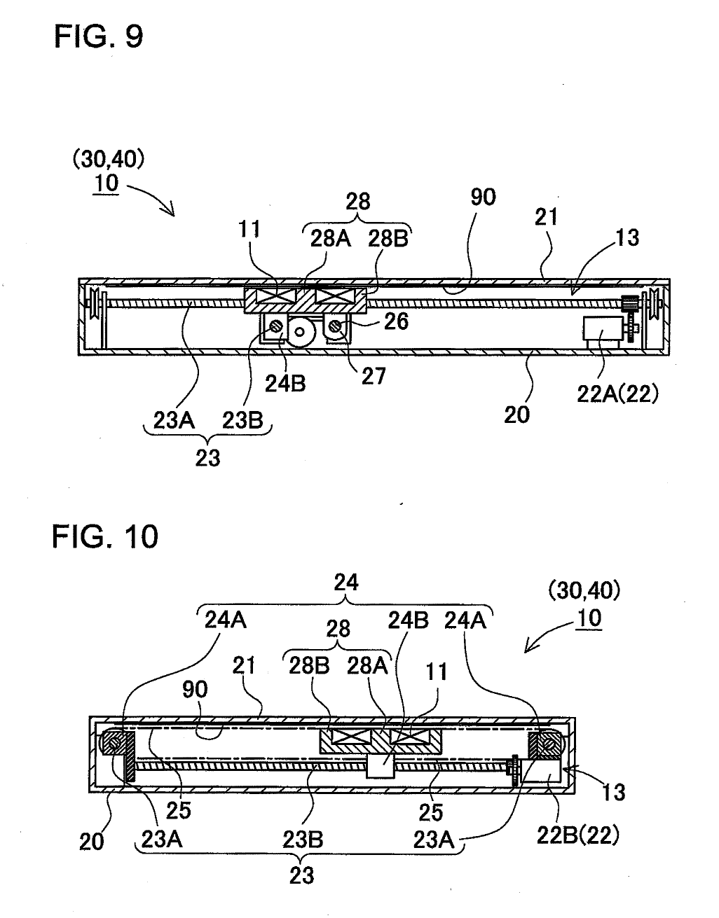

FIGS. 1 through 4 and 8 through 11 are schematic construction diagrams and principle diagrams of the charging base 10 (30, 40) that bears the battery-containing unit 50 (70, 80) and charge the lithium ion battery 60 that is contained in the battery-containing unit 50 (70, 80) by magnetic induction. The illustrated charging base 10 (30, 40) includes the energizing coil 11 that is connected to the high frequency power supply 12 to produce an electromotive force in the energized coil 51, a case 20 that accommodates the energizing coil 11 and has an upper plate 21 on its upper side that bears the battery-containing unit 50 (70, 80), an actuating mechanism 13 that is accommodated In the case 20 and moves the energizing coil 11 along the inner surface of the upper plate 21, and a position detecting controller 18 that detects the position of the battery-containing unit 50 (70, 80) borne on the upper plate 21 and controls the actuating mechanism 13 to move the energizing coil 11 to a position close to the energized coil 51 of the battery-containing unit 50 (70, 80). The case 20 of the charging base 10 (30, 40) accommodates the energizing coil 11, the high frequency power supply 12, the actuating mechanism 13, and the position detecting controller 18.

The charging base 10 (30, 40) charges the lithium ion battery 60 of the battery-containing unit 50 (70, 80) as follows:
(1) when the battery-containing unit 50 (70, 80) is placed on the upper plate 21 of the case 20, the position detecting controller 18 detects the position of the battery-containing unit 50 (70, 80).
(2) after detecting the position of the battery-containing unit 50 (70, 80), the position detecting controller 18 controls the actuating mechanism 13 to move the energizing coil 11 along the upper plate 21 to a position close to the energized coil 51 of the battery-containing unit 50 (70, 80).
(3) the energizing coil 11 in proximity to the energized coil 51 is inductively connected to the energized coil 51 to transmit AC power to the energized coil 51.
(4) the charging circuit 52 of the battery-containing unit 50 (70, 80) rectifies the AC power of the energized coil 51 and converts it into a direct current, and the lithium ion battery 60 is charged with the direct current.

In the charging base 10 (30, 40) that thus charges the lithium ion battery 60 of the battery-containing unit 50 (70, 80), the energizing coil 11 connected to the high frequency power supply 12 is contained in the case 20. The energizing coil 11 is located under the upper plate 21 of the case 20 to be moved along the upper plate 21. The efficiency of power transmission from the energizing coil 11 to the energized coil 51 can be improved by reduction of the interval between the energizing coil 11 and the energized coil 51. Preferably, the interval between the energizing coil 11 and the energized coil 51 is not more than 7 mm when the energizing coil 11 is located at the position close to the energized coil 51. To achieve this, the energizing coil 11 is located under the upper plate 21 as closer as possible to the upper plate 21. In order that the energizing coil 11 may be moved to approach the energized coil 51 of the battery-containing unit 50 placed on the upper plate 21, the energizing coil 11 is configured to move along the lower surface of the upper plate 21.

The case 20 that accommodates the energizing coil 11 has the flat upper surface plate 21 on its upper side that bears the battery-containing unit 50 (70, 80). In the illustrated charging base 10 (30, 40), the upper plate 21 has a flat shape that is horizontally oriented as a whole. The upper plate 21 has a size capable of bearing various types of battery-containing units 50 (70, 80) with different sizes and exterior shapes on its upper surface (e.g., a rectangular shape with a side of 5 cm to 30 cm, or an oval shape with a diameter of 5 cm to 30 cm). In the case where the charging base has a large upper plate, in other words, has a size capable of bearing a plurality of battery-containing units, a plurality of battery-containing units can be placed together on the charging base so that the contained batteries can be charged one after another. The upper plate may have a peripheral wall or the like around its periphery. In this case, the battery-containing unit can be placed inside the peripheral wall so that the contained battery can be charged.

The energizing coil 11 is spirally coiled on a plane parallel to the upper plate 21, and produces AC magnetic flux upward of the upper plate 21. The energizing coil 11 produces the AC magnetic flux perpendicular to the upper plate 21 upward of the upper plate 21. The energizing coil 11 is provided with AC power from the high frequency power supply 12 to produce the AC magnetic flux upward of the upper plate 21. The inductance of the energizing coil 11 can be increased by coiling a wire line around a core 28 formed of a magnetic material. The core 28 is formed of a high-permeability material such as ferrite, and is a pot core that opens upward. The pot core 28 has a pillar portion 28A and a cylindrical wall portion 28B that are coupled to the bottom of the core 28. The pillar portion 28A is arranged at the center of the spirally-wound energizing coil 11. The cylindrical wall portion 28B is arranged the outer periphery of the core 28. The energizing coil 11 with the core 28 concentrates the magnetic flux into a particular part, and can efficiently transmit power to the energized coil 51. It should be appreciated that the energizing coil does not necessarily include the core but can be a coreless coil. Since a coreless coil is light, it is possible to simplify the actuating mechanism that moves the coil under the interior surface of the upper plate. The energizing coil 11 has an outer diameter substantially equal to the energized coil 51 in order to efficiently transmit power to the energized coil 51.

The high frequency power supply 12 is connected to the energizing coil 11 via a flexible lead line 29. The reason is that the energizing coil 11 is moved to approach the energized coil 51 of the battery-containing unit 50 (70, 80) that is placed on the upper plate 21. Although not illustrated, the high frequency power supply 12 includes a self-excited oscillating circuit, and a power amplifier that amplifies power of an alternating current provided from the oscillating circuit. The self-excited oscillating circuit uses the energizing coil 11 as an oscillating coil. Accordingly, the oscillation frequency of the oscillating circuit varies according to the inductance of the energizing coil 11. The inductance of the energizing coil 11 varies according to the relative position between the energizing coil 11 and the energized coil 51. The reason is that the mutual inductance of the energizing coil 11 and the energized coil 51 varies according to the relative position between the energizing coil 11 and the energized coil 51. Accordingly, in the case of the self-excited oscillating circuit that uses the energizing coil 11 as the oscillating coil, the oscillation frequency varies as the high frequency power supply 12 approaches the energized coil 51. For this reason, the self-excited oscillating circuit can detect the relative position between the energizing coil 11 and the energized coil 51 based on the variation of the oscillation frequency, and can serve as the position detecting controller 18.

The energizing coil 11 is moved by the actuating mechanism 13 to approach the energized coil 51. The actuating mechanism 13 shown in FIGS. 1 and 8 through 10 moves the energizing coil 11 in X and Y directions along the upper plate 21 so that the energizing coil 11 approaches the energized coil 51. The illustrated actuating mechanism 13 rotates threaded rods 23 by means of servo motors 22 controlled by the position detecting controller 18 to move nut members 24 screwed onto the threaded rods 23 so that the energizing coil 11 approaches the energized coil 51. The servo motors 22 are X-directional and Y-directional servo motors 22A and 22B that move the energizing coil 11 in the X and Y directions, respectively. The threaded rods 23 are a pair of X-directional 23A that move the energizing coil 11 in the X direction, and a Y directional threaded rod 23B that moves the energizing coil 11 in the Y direction. The pair of X-directional threaded rods 23A are arranged in parallel to each other, and are driven through belts 25 by the X-directional servo motor 22A to rotate together. The nut members 24 are a pair of X-directional nut members 24A that are screwed onto the X-directional threaded rods 23A, and a Y-directional nut member 24B that is screwed onto the Y-directional threaded rod 23B. The both ends of the Y-directional threaded rod 23B are rotatably coupled to the pair of X-directional nut members 24A. The energizing coil 11 is coupled to the Y-directional nut member 24B.

The illustrated actuating mechanism 13 includes a guide rod 26 in parallel to the Y-directional threaded rod 23B in order to move the energizing coil 11 in the Y-direction in a horizontal orientation. The both ends of the guide rod 26 are coupled to the pair of X-directional nut members 24A so that the guide rod moves together with the pair of X-directional nut members 24A. The guide rod 26 penetrates a guide portion 27 coupled to the energizing coil 11 so that the energizing coil 11 can be moved in the Y-direction along the guide rod 26. That is, the energizing coil 11 is moved in the Y-direction in the horizontal orientation through the Y-directional nut member 24B and the guide portion 27 that are moved along the Y-directional threaded rod 23B and the guide rod 26 arranged in parallel to each other.

In the actuating mechanism 13, when the X-directional servo motor 22A rotates the X-directional threaded rod 23A, the pair of X-directional nut members 24A are moved along the X-directional threaded rods 23A so that the Y-directional threaded rod 23B and the guide rod 26 are moved in the X-direction. When the Y-directional servo motor 22B rotates the Y-directional threaded rod 23B, the Y-directional nut member 24B is moved along the Y-directional threaded rod 23B so that the energizing coil 11 is moved in the Y-direction. The guide portion 27 coupled to the energizing coil 11 is moved along the guide rod 26 to move the energizing coil 11 in the Y-direction in the horizontal orientation. Thus, the position detecting controller 18 controls the rotation of the X-axis servo motor 22A and the Y-axis servo motor 22B so that the energizing coil 11 can be moved in the X and Y directions. However, the actuating mechanism of the charging base is not limited to the aforementioned mechanism. The reason is that the actuating mechanism can employ any mechanisms that can move the energizing coil in the X and Y directions.

Also, the actuating mechanism of the charging base is not limited to the mechanism that moves the energizing coil in the X and Y directions. The reason is that the charging base can be configured to be provided with a straight guide wall on the upper plate to bear the battery-containing unit along the guide wall, and can be configured to linearly move the energizing coil along the guide wall. In this case, although not illustrated, the thus-configured charging base can include an actuating mechanism that moves the energizing coil in one direction, for example, the X direction, to lineally move the energizing coil along the guide wall.

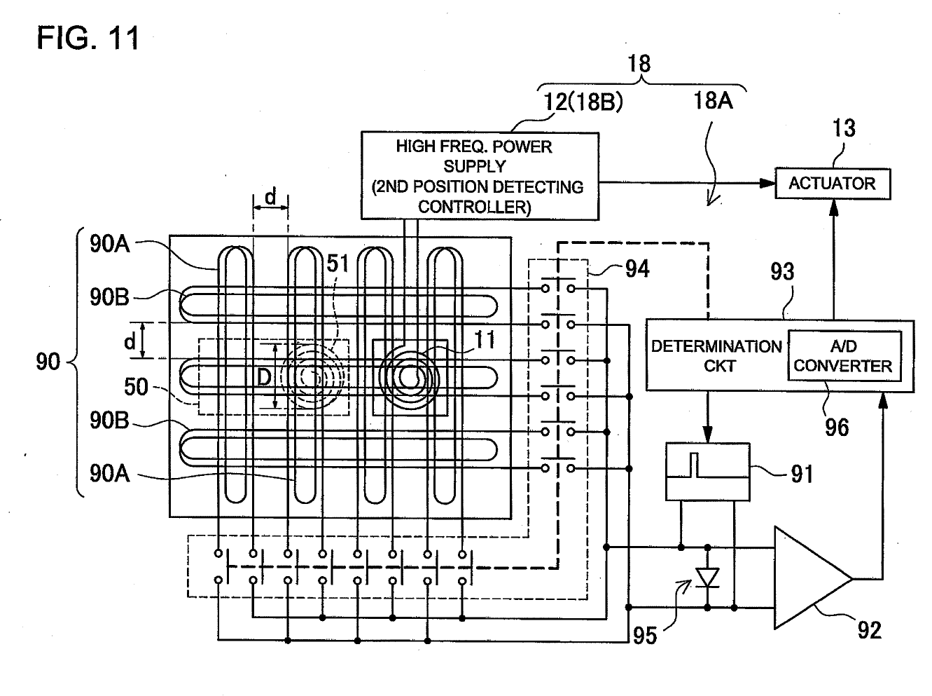

The position detecting controller 18 detects the position of the battery-containing unit 50 (70, 80) placed on the upper plate 21. The position detecting controller 18 shown in FIGS. 2 and 11 detects the position of the energized coil 51 contained in the battery-containing unit 50, and causes the energizing coil 11 to approach the energized coil 51. The position detecting controller 18 includes a first position detecting control portion 18A that roughly detects the position of the energized coil 51, and a second position detecting control portion 18B that precisely detects the position of the energized coil 51. The position detecting controller 18 roughly detects the position of the energized coil 51 by means of the first position detecting control portion 18A, and controls the actuating mechanism 13 so that the position of the energizing coil 11 approaches the energized coil 51. After that, the position detecting controller 18 precisely detects the position of the energized coil 51 by means of the second position detecting control portion 18B, and controls the actuating mechanism 13 so that the position of the energizing coil 11 accurately approaches the energized coil 51. This charging base 10 can cause the energized coil 51 to quickly and more accurately approach the energizing coil 11.

As shown in FIG. 11, the first position detecting control portion 18A includes a plurality of position detecting coils 90 that are secured to the interior surface of the upper plate 21, a pulse power supply 91 that provides pulse signals to the position detecting coils 90, a receiving circuit 92 that receives echo signals that are excited by the pulses provided from this pulse power supply 91 to the position detecting coil 90 and are provided from the energized coil 51 to the position detecting coils 90, and a determination circuit 93 that determines the position of the energizing coil 11 based on the echo signals received by the receiving circuit 92.

The position detecting coils 90 are a plurality of rows of coils. The plurality of position detecting coils 90 are secured on the interior surface of the upper plate 21, and are spaced away from each other at a predetermined interval. The position detecting coils 90 are a plurality of X-directional and Y-directional detecting coils 90A and 90B that detect the X-directional and Y-directional positions of the energized coil 51, respectively. Each of the X-directional detecting coils 90A has a loop shape that elongates in the Y direction. A plurality of X-directional detecting coils 90A are secured on the interior surface of the upper plate 21, and are spaced away form each other at a predetermined interval. The interval (d) between the adjacent X-directional detecting coils 90A is smaller than the outer diameter (D) of the energized coil 51. The interval (d) between the X-directional detecting coils 90A is preferably ¼ to 1 time as long as the outer diameter (D) of the energized coil 51. Reduction of the interval (d) allows the X-directional detecting coil 90A to accurately detect the X-directional position of the energized coil 51. Each of the Y-directional detecting coils 90B has a loop shape that elongates in the X direction. A plurality of Y-directional detecting coils 90B are secured on the interior surface of the upper plate 21, and are spaced away form each other at a predetermined interval. Similar to the X-directional detecting coil 90A, the interval (d) between the adjacent Y-directional detecting coils 90B is smaller than the outer diameter (D) of the energized coil 51. The interval (d) between the Y-directional detecting coils 90B is preferably ¼ to 1 time as long as the outer diameter (D) of the energized coil 51. Also, reduction of the interval (d) allows the Y-directional detecting coil 90B to accurately detect the Y-directional position of the energized coil 51.

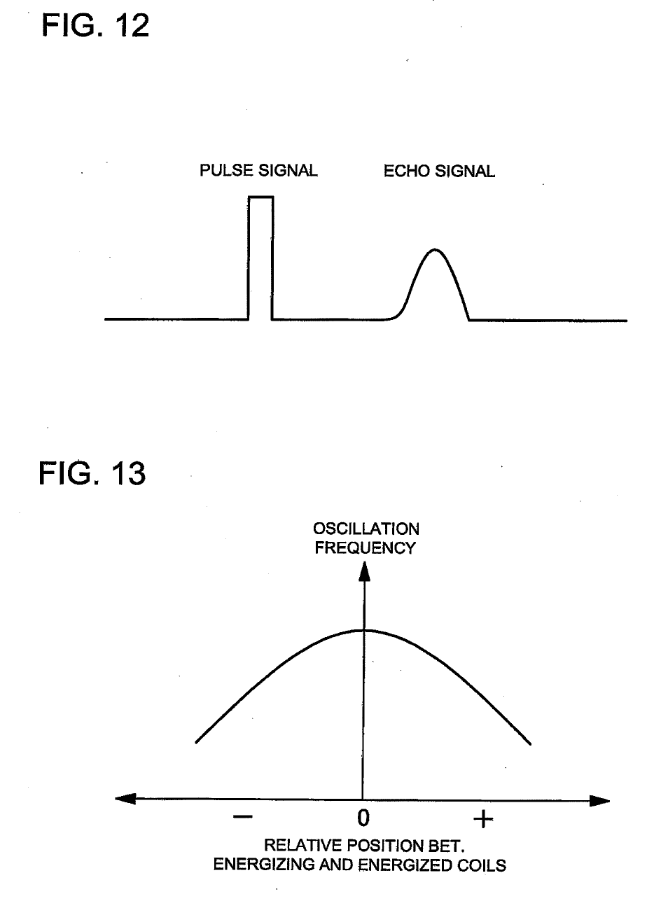

The pulse power supply 91 provides the pulse signals to the position detecting coils 90 at predetermined timing. The position detecting coil 90 that receives the pulse signal excites the energized coil 51 in proximity to the position detecting coil 90 with the pulse signal. The excited energized coil 51 provides the echo signal to the position detecting coils 90 with energy of a current that flows in the energized coil 51. Accordingly, after the energized coil 51 receives the pulse signal, the echo signal from the energized coil 51 is produced in the position detecting coil 90 that Is located close to the energized coil 51 with a predetermined delay as shown in FIG. 12. The echo signal produced in the position detecting coil 90 is provided to the determination circuit 93 from the receiving circuit 92. Thus, the determination circuit 93 determines whether the energized coil 51 is located close to one of the position detecting coils 90 based on the echo signal provided from the receiving circuit 92. When the echo signals are produced in a plurality of position detecting coils 90, the determination circuit 93 determines that the energized coil is located closest to one of the position detecting coils 90 that receives a large echo signal level.

In the position detecting controller 1 8 shown in FIG. 11, the position detecting coils 90 are connected to the receiving circuit 92 through the switching circuit 94. Since the plurality of position detecting coils 90 are connected selectively connected to the receiving circuit 92 one after another, this position detecting controller 18 can detect the echo signals of the plurality of position detecting coils 90 by means of one receiving circuit. It should be appreciated that the receiving circuits may be connected to the position detecting coils to detect the echo signals.

The position detecting controller 18 shown in FIG. 11 switches a plurality of position detecting coils 90 one after another to be connected to the receiving circuit 92 by means of the switching circuit 94 that is controlled by the determination circuit 93. The pulse power supply 91 is connected to the output side of the switching circuit 94, and provides the pulse signals to the position detecting coils 90. The level of the pulse signals provided from the pulse power supply 91 to the position detecting coil 90 is much large as compared with the echo signals from the energized coil 51. A limiter circuit 95 composed of a diode is connected to the receiving circuit 92 on the input side. The limiter circuit 95 limits the signal level of the pulse signals provided from the pulse power supply 91 to the receiving circuit 92, and provides the pulse signals to the receiving circuit 92. The echo signals with small signal level are provided to the receiving circuit 92 without limitation. The receiving circuit 92 amplifies and then provides both the pulse signal and the echo signal. The echo signal provided from the receiving circuit 92 delays at predetermined timing, for example, several μsec to several hundreds μsec from the pulse signal. Since the delay time of the echo signal from the pulse signal is a fixed time, a signal delayed at the fixed time from the pulse signal is the echo signal. Thus, it is determined whether the energized coil 51 is located close to one of the position detecting coils 90 based on the level of this echo signal.

The receiving circuit 92 is an amplifier that amplifies and then provides the echo signals that are provided from the position detecting coils 90. The receiving circuit 92 provides the pulse signals and the echo signals. The determination circuit 93 determines whether the energized coil 51 is placed close to one of the position detecting coils 90 based on the pulse signals and the echo signals provided from the receiving circuit 92. The determination circuit 93 includes an A/D converter 96 that converts the signals provided from the receiving circuit 92 into digital signals. The echo signal is detected based on calculation of the digital signal provided from the A/D converter 96. The determination circuit 93 detects a signal that is provided after a given delay time from the pulse signal as an echo signal, and determines whether the energized coil 51 is located close to one of the position detecting coils 90 based on the level of the echo signal.

The determination circuit 93 controls the switching circuit 94 to connect the plurality of X-directional detecting coils 90A to the receiving circuit 92 one after another to detect the X-directional position of the energized coil 51. Every when connecting one of the X-directional detecting coils 90A to the receiving circuit 92, the determination circuit 93 provides the pulse signal to the one of the X-directional detecting coils 90A that is connected to the determination circuit 93. The determination circuit 93 determines whether the energized coil 51 is located close to this X-directional detecting coil 90A based on whether the echo signal is detected after the given delay time from the pulse signal. The determination circuit 93 thus connects all the X-directional detecting coils 90A to the receiving circuit 92 to detect whether the energized coil 51 is located close to any of the X-directional detecting coils 90A. If the energized coil 51 is located close to any of X-directional detecting coils 90A, the echo signal will be detected when this X-directional detecting coil 90A is connected to the receiving circuit 92. Accordingly, the determination circuit 93 can detect the X-directional position of the energized coil 51 by means of the X-directional detecting coils 90A that can detect the echo signals. In the case where the energized coil 51 straddles two or more of the X-directional detecting coils 90A, the echo signals will be detected from the two or more of the X-directional detecting coils 90A. In this case, the determination circuit 93 determines that the energized coil is located close to one of the X-directional detecting coils 90A that detects the strongest echo signal, that is, an echo signal with the highest level. The determination circuit 93 similarly controls the Y-directional detecting coil 90B to detect the Y-directional position of the energized coil 51.

The determination circuit 93 controls the actuating mechanism 13 based on the X and Y directional positions to move the energizing coil 11 to the position close to the energized coil 51. The determination circuit 93 controls the X-directional servo motor 22A of the actuating mechanism 13 to move the energizing coil 11 to the X-directional position of the energized coil 51. Also, the determination circuit controls the Y-directional servo motor 22B of the actuating mechanism 13 to move the energizing coil 11 to the Y-directional position of the energized coil 51.

Thus, the first position detecting control portion 18A moves the energizing coil 11 to the position close to the energized coil 51. After moving the energizing coil 11 to a position close to the energized coil 51 by the first position detecting control portion 18A, the charging base can transmit power from the energizing coil 11 to the energized coil 51 to charge the lithium ion battery 60. Alternatively, after accurately controlling the position of the energizing coil 11 to move the energizing coil 11 to the position close to the energized coil 51, the charging base can charge the lithium ion battery 60. The energizing coil 11 is more accurately moved to the position close to the energized coil 51 by the second position detecting control portion 18B.

The second position detecting control portion 1 8B accurately detects the position of the energizing coil 11 by means of the high frequency power supply 12 as a self-excited oscillating circuit based on the oscillation frequency of the self-excited oscillating circuit, and the actuating mechanism 13 is controlled. The second position detecting control portion 18B controls the X-directional servo motor 22A and the Y-directional servo motor 22B of the actuating mechanism 13 to move the energizing coil 11 in the X and Y directions, and detects the oscillation frequency of the high frequency power supply 12. FIG. 13 shows the characteristic of variation of the oscillation frequency of the self-excited oscillating circuit. This diagram shows the variation of the oscillation frequency in relation to positional deviation between the energizing coil 11 and the energized coil 51. As shown in this diagram, the oscillation frequency of the self-excited oscillating circuit becomes the highest when the energizing coil 11 is located at the position closest to the energized coil 51, and the oscillation frequency decreases as deviation of the relative position increases. Accordingly, the second position detecting control portion 18B controls the X-directional servo motor 22A of the actuating mechanism 13 to move the energizing coil 11 in the X direction, and stops the movement of the energizing coil 11 at the position where the oscillation frequency is the highest. In addition, the Y-directional servo motor 22B is similarly controlled to move the energizing coil 11 in the Y direction, and the movement of the energizing coil 11 is stopped at the position where the oscillation frequency is the highest. Thus, the second position detecting control portion 18B can move the energizing coil 11 to the position closest to the energized coil 51.

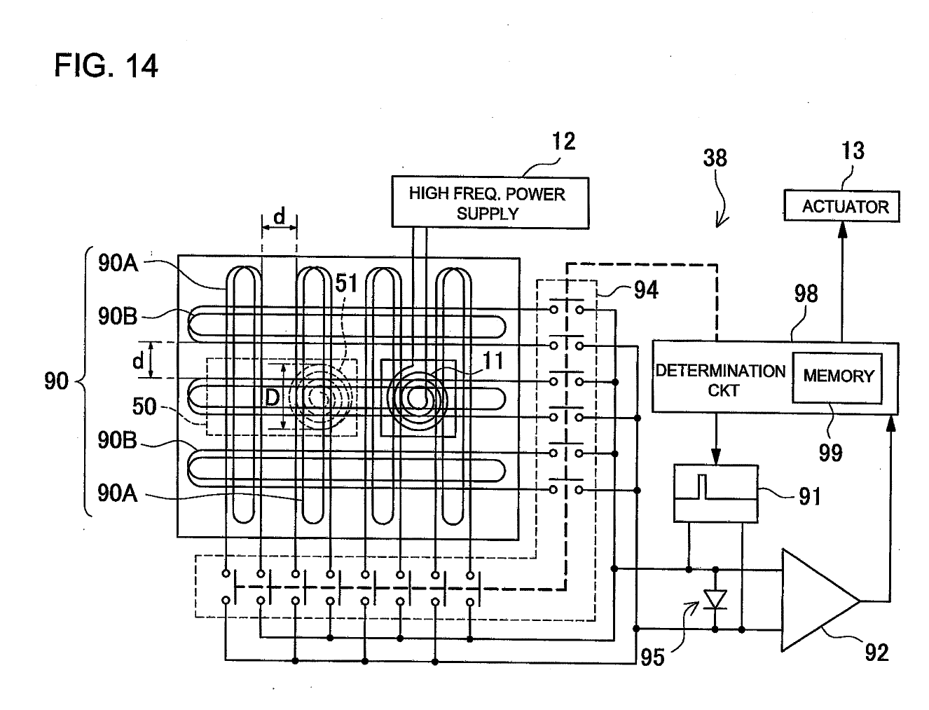

After roughly detecting the position of the energized coil 51 by means of the first position detecting control portion 18A, the aforementioned charging base finely adjusts the position of the energized coil 51 by means of the second position detecting controlling portion 18B so that the energizing coil 11 is located close to the energized coil 51. On the other hand, the following position detecting controller 38 shown In FIG. 14 can move the energized coil 51 to the position close to the energizing coil 11 without finely adjustment.

As shown in FIG. 14, the position detecting controller 38 includes a plurality of position detecting coils 90 that are secured to the Interior surface of the upper plate, a pulse power supply 91 that provides pulse signals to the position detecting coils 90, a receiving circuit 92 that receives echo signals that are excited by the pulses provided from this pulse power supply 91 to the position detecting coil 90 and are provided from the energized coil 51 to the position detecting coils 90, and a determination circuit 98 that determines the position of the energizing coil 11 based on the echo signals received by the receiving circuit 92. In addition, the determination circuit 98 of the position detecting controller 38 includes a memory circuit 99 that stores the levels of the echo signals produced in the position detecting coils 90 in relation to the positions of the energized coil 51, in other words, the levels of the echo signals that are produced when a predetermined time period elapses after the position detecting coil 90 is excited by the pulse signals, as shown in FIG. 12. The position detecting controller 38 detects the level of the echo signal produced in the position detecting coils 90, and compares the level of the detected echo signal with the levels of the echo signals stored in the memory circuit 99 to detect the position of the energized coil 51.

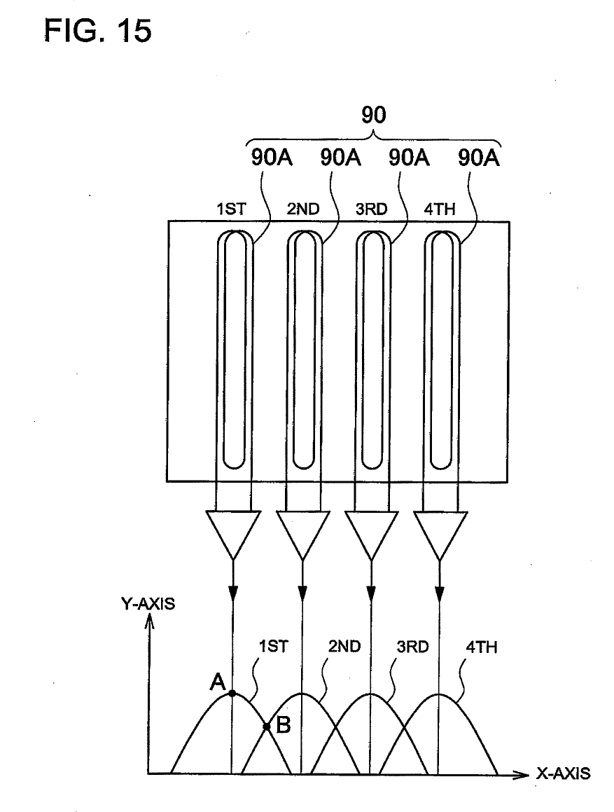

The position detecting controller 38 calculates the position of the energized coil 51 based on the levels of the echo signals produced in the position detecting coils 90 as follows. The position detecting coils 90 shown in FIG. 14 are a plurality of X-directional and Y-directional detecting coils 90A and 90B that detect the X-directional and Y-directional positions of the energized coil 51, respectively. The plurality of position detecting coils 90 are secured on the interior surface of the upper plate 21, and are spaced away from each other at a predetermined interval. Each of the X-directional detecting coils 90A has a loop shape that elongates in the Y direction. Each of the Y-directional detecting coils 90B has a loop shape that elongates in the X direction. FIG. 15 is a diagram showing the levels of the echo signals produced in the X-directional position detecting coils 90A in the case where the energized coil 51 is moved in the X direction. The horizontal axis represents the X-directional position of the energized coil 51. The vertical axis represents the level of the echo signal produced in each of the X-directional position detecting coils 90A. The position detecting controller 38 calculates the X-directional position of the energized coil 51 based on detection of the levels of the echo signals produced in the X-directional position detecting coils 90A. As shown in this diagram, when the energized coil 51 is moved in the X direction, the level of echo signal varies that is produced in each of the X-directional position detecting coils 90A. For example, when the center of the energized coil 51 is located at the center of a first X-directional position detecting coil 90A, as shown by a point A in FIG. 15, the level of the echo signal produced in the first X-directional position detecting coil 90A becomes the highest. When the energized coil 51 is located at the midpoint between the first X-directional position detecting coil 90A and a second X-directional position detecting coil 90A, as shown by a point B in FIG. 15B, the levels of the echo signals are the same that are produced in the first and second X-directional position detecting coils 90A. That is, when the energized coil 51 is located at a position closest to one of the X-directional position detecting coils 90A, the level of the echo signal produced in the X-directional position detecting coil 90A becomes the highest, and the level of the echo signal decreases as the energized coil 51 is moved away from the X-directional position detecting coil 90A. Accordingly, it can be determined which of the X-directional position detecting coils 90A is located closest to the energized coil 51 based on which of the levels of the echo signals of the X-directional position detecting coils 90A is the highest. In the case where the echo signals are produced in two of the X-directional position detecting coils 90A, based on, relative to one of the X-directional position detecting coils 90A that detects the highest echo signal, which direction another X-directional position detecting coil 90A that detects the other echo signal is located, it can be determined which direction the energized coil 51 is deviated from the X-directional position detecting coil 90A corresponding to the highest echo signal. In addition, the position of the energized coil 51 relative to the two X-directional position detecting coils 90A can be detected based on the level ratio of the echo signals. For example, if the level ratio of the echo signals of the two X-directional position detecting coils 90A is 1, it can determine that the energized coil 51 is located at the midpoint between the two X-directional position detecting coils 90A.

The memory circuit 99 of the determination circuit 73 stores the levels of the echo signals produced in the X-directional position detecting coils 90A in relation to the X-directional position of the energized coil 51. If the energized coil 51 is placed, the echo signal will be produced in any of the X-directional position detecting coils 90A. Thus, the determination circuit 98 detects that the energized coil 51 is placed, in other words, that the battery-containing unit is placed on the charging base based on the echo signal produced in the X-directional position detecting coil 90A. In addition, the X-directional position of the energized coil 51 can be determined based on comparison of the level of the echo signal produced in one of the X-directional position detecting coils 90A with the levels stored in the memory circuit 99. The memory circuit of the determination circuit can store a function that determines the X-directional position of the energized coil based on the level ratio of the echo signals produced in the adjacent X-directional position detecting coils to determine the position of the energized coil based on the function. The function can be obtained by detecting, when the energized coil is moved between two X-directional position detecting coils, the level ratios of the echo signals produced in the X-directional position detecting coils. The determination circuit 98 detects the level ratio of the echo signals produced in two X-directional position detecting coils 90A, and can calculate and detect the X-directional position of the energized coil 51 between the two X-directional position detecting coils 90A by substituting the detected level ratio in the function.

As stated above, the determination circuit 98 detects the X-directional position of the energized coil 51 based on the echo signals produced in the X-directional position detecting coils 90A. The Y-directional position of the energized coil 51 can be detected based on the echo signals produced in the Y-directional position detecting coils 90B similarly to the X-directional position.

When the determination circuit 98 detects the X-directional and Y-directional positions of the energized coil 51, the position detecting controller 38 moves the energizing coil 11 to the position of the energized coil 51 based on the position signals from this determination circuit 98.

When the echo signal with the aforementioned waveform is detected, the determination circuit 98 of the charging base can recognize and determines that the energized coil 51 of the battery-containing unit 50 (70, 80) is placed on the charging base. If a waveform different from the waveform of the echo signal is detected and determined, it is determined that something other than the energized coil 51 of the battery-containing unit 50 (70, 80), for example, a metal foreign object is placed on the charging base, and power supply can be stopped. Also, in the case where the waveform of the echo signal is not detected and determined. It is determined that the energized coil 51 of the battery-containing unit 50 (70, 80) is not placed on the charging base, and power is supplied.

The charging base 10, (30, 40) controls the actuating mechanism 13 by means of the position detecting controller 18 (38) to positions the energizing coil 11 at the position close to the energized coil 51, and then supplies AC power to the energizing coil 11 by means of the high frequency power supply 12. The AC power of the energizing coil 11 is transmitted to the energized coil 51, and is used to charge the lithium ion battery 60. The battery-containing unit 50 (70, 80) detects the voltage, current and temperature of the lithium ion battery 60 to be charged by means of the detecting circuit 53, and transmits the voltage, current and temperature detected by the detecting circuit 53 as the voltage, current and temperature signals from the transmitter 54 (74, 84) to the charging base 10 (30, 40). The charging base 10 (30, 40) receives the voltage, current and temperature signals transmitted from the transmitter 54 (74, 84) by means of the receiver 14 (34, 44), and controls the high frequency power supply 12 through the feedback circuit 17. The feedback circuit 17 controls the output of the high frequency power supply 12 so that the lithium ion battery 60 is charged at a constant voltage and a constant current.

When the lithium ion battery 60 is fully charged, the detecting circuit 53 determines that the lithium ion battery 60 is fully charged, and the battery-containing unit 50 (70, 80) transmits a full charge signal to the charging base 10 (30, 40). For example, when a charging current of the lithium ion battery 60 becomes lower than a preset current, the detecting circuit 53 determines that the lithium ion battery 60 is fully charged, and provides the full charge signal. The full charge signal is transmitted from the transmitter 54 (74, 84) of the battery-containing unit 50 (70, 80) to the charging base 10 (30, 40). When receiving the full charge signal transmitted from the transmitter 54 (74, 84) by means of the receiver 14 (34, 44), the charging base 10 (30, 40) controls the high frequency power supply 12 through the feedback circuit 17 to stop power transmission by the energizing coil 11 so that the charging operation of the lithium ion battery 60 is completed.

The transmitter 54 of the battery-containing unit 50 shown in FIG. 2 modulates the carrier waves that indicate the full charge signal by means of the modulating circuit 55, and wirelessly transmits the modulated signal from the transmitting antenna 56. The receiver 14 of the charging base 10 receives the radio waves by means of the receiving antenna 16. The receiver 14 demodulates the signal received by the receiving antenna 16 by means of the receiving circuit 15, and detects the full charge signal. It should be appreciated that the full charge signal of the lithium ion battery may be wirelessly transmitted not by the transmitting antenna and the receiving antenna after the carrier waves are modulated but similarly to the aforementioned battery-containing units 70 and 80 shown in FIGS. 3 and 4 that transmit information on the lithium ion battery 60 to the charging bases 30 and 40, that is, may be transmitted from the battery-containing unit 70 (80) to the charging base 30 (40) through the energized coil 51 and the energizing coil 11.

Also, the fully-charged state of the lithium ion battery charged may be detected not by the detecting circuit of the battery-containing unit but by the charging base. In this case, the charging base detects the charging current of the charged lithium ion battery based on the current signal transmitted from the battery-containing unit. When the current value becomes smaller than a preset current, the charging base determines that the lithium ion battery is fully charged, and controls the high frequency power supply so that power is not transmitted from the energizing coil.

In the case of the charging base 10 where a plurality of battery-containing units 50 can be placed on the upper plate 21, the charging base 10 can charge the lithium ion batteries 60 of the plurality of battery-containing units 50 in turn to the fully-charged state. The charging base 10 detects the position of the energized coil 51 of a first battery-containing unit 50, and moves the energizing coil 11 to a position close to this energized coil 51 to charge the lithium ion battery 60 of this battery-containing unit 50 to the fully-charged state. When the lithium ion battery 60 of this battery-containing unit 50 is fully charged, the full charge signal is received. The position detecting controller 18 then detects the position of the energized coil 51 of a second battery-containing unit 50 that is placed on a position other than the fully-charged battery-containing unit 50, and controls the actuating mechanism 13 to move the energizing coil 11 to a position close to the energized coil 51 of the second battery-containing unit 50. After that, power is transmitted to the lithium ion battery 60 of the second battery-containing unit 50, and this lithium ion battery 60 will be fully charged. Also, when the lithium ion battery 60 of the second battery-containing unit 50 is fully charged, the full charge signal is received from the second battery-containing unit 50. After that, the position detecting controller 18 additionally detects the energized coil 51 of a third battery-containing unit 50, and controls the actuating mechanism 13 to move the energizing coil 11 to a position close to the energized coil 51 of the third battery-containing unit 50. The lithium ion battery 60 of the third battery-containing unit 50 will be then fully charged. As stated above, in the case where a plurality of battery-containing units 50 are placed on the upper plate 21, the lithium ion batteries 60 of the battery-containing units 50 are charged one after another to the fully-charged state. This charging base 10 stores the position of the battery-containing unit 50 that have been fully charged, and does not charge the lithium ion battery 60 of the fully-charged battery-containing unit 50 again. If determining that the lithium ion batteries 60 of all the battery-containing units 50 placed on the upper plate 21 are fully charged, the charging base 10 stops operation of the high frequency power supply 12 to stop charging operation of the lithium Ion battery 60.

The thus-configured charging base 10 (30, 40) detects the position of the battery-containing unit 50 (70, 80) placed on the upper surface of the case 20 by means of the position detecting controller 18, and controls the actuating mechanism 13 to move the energizing coil 11 to the position close to the energized coil 51 of the battery-containing unit 50 (70, 80). Accordingly, there is a feature in that power can be efficiently transmitted from the energizing coil 11 to the energized coil 51, and the lithium ion battery 60 can be efficiently charged that is contained in the battery-containing unit 50 (70, 80). In particular, in the case where the position detecting controller 18 detects the position of the energized coil 51 of the battery-containing unit 50 (70, 80), and controls the actuating mechanism 13 to move the energizing coil 11 to the position close to the energized coil 51, there is a feature in that information including the voltage and the like of the lithium ion battery 60 detected by the detecting circuit 53 can be reliably transmitted from the battery-containing unit 50 (70, 80) to the charging base 10 (30,40). The reasons are that, in the case where information is transmitted through the transmitting antenna 56 and the receiving antenna 16 as shown in FIG. 2, the energized coil 51 and the energizing coil 11 are located in proximity to the transmitting antenna 56 and the receiving antenna 16, respectively, so that the radio waves can be reliably transmitted from the transmitter 54 to the receiver 14 through the transmitting antenna 56 and the receiving antenna 16 located in proximity to each other, and that, in the case where information is transmitted through the energized coil 51 and the energizing coil 11 as shown in FIGS. 3 and 4, the energizing coil 11 is moved to the position close to the energized coil 51 so that the signals can be reliably transmitted from the energized coil 51 to the energizing coil 11 to accurately transmit the information including the voltage and the like of the lithium ion battery 60 to the charging base 30 (40).

However, the charger of the present invention is not limited to the aforementioned configuration. Although not illustrated, the charger may include a mount portion to which the battery-containing unit is detachably attached at a predetermined position. In this charger, the energizing coil is arranged at the position opposed to the energized coil so that power can be transmitted to the energized coil of the battery-containing unit mounted to the mount portion. After the battery-containing unit is mounted to the mount portion so that the induction coil is arranged at a predetermined position in the charging base, in other words, the energized coil and the energizing coil are located close to each other, the charging base reliably transmits power and efficiently charges the lithium ion battery contained in the battery-containing unit. In addition, the information including the voltage and the like of the lithium ion battery detected by the detecting circuit of the battery-containing unit can be reliably transmitted from the battery-containing unit to the charging base.

It should be apparent to those with an ordinary skill in the art that while various preferred embodiments of the Invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the scope of the invention as defined in the appended claims. The present application is based on Application No. 2008-124105 filed in Japan on May 10, 2008, the content of which is contained herein by reference.

What is claimed is:

1. A battery-containing unit and a charging base, wherein the battery-containing unit includes an energized coil and a lithium ion battery to be charged by electric power produced in the energized coil, and the charging base that receives the battery-containing unit and charges the lithium ion battery of the battery-containing unit,
wherein said battery-containing unit comprises
a charging circuit that rectifies an alternating current produced in the energized coil to convert the alternating current into a direct current for charging the lithium ion battery,
a detecting circuit that detects the voltage of the lithium ion battery to be charged, and
a transmitter that transmits a voltage signal detected by the detecting circuit to the charging base,
wherein said charging base comprises
a receiver that receives signals transmitted from the transmitter of said battery-containing unit, and detects the voltage signal of the lithium ion battery,
an energizing coil to transmit AC power to said energized coil, and
a high frequency power supply that is controlled based on the voltage signal detected by the receiver to provide AC power to said energizing coil whereby charging the lithium ion battery at a voltage not greater than a predetermined voltage, and
wherein the high frequency power supply of the charging base detects the voltage of the lithium ion battery to be charged through the receiver and the transmitter, and is controlled based on the detected voltage to charge the lithium Ion battery at a voltage not exceeding the predetermined voltage.

2. The battery-containing unit and the charging base according to claim 1, wherein the detecting circuit of said battery-containing unit detects the voltage and the current of the lithium ion battery to be charged, and the transmitter of said battery-containing unit transmits the voltage signal and a current signal detected by the detecting circuit to the charging base, wherein the receiver of said charging base receives the signals transmitted from the transmitter of said battery-containing unit and detects the voltage signal and the current signal of the lithium ion battery, and the high frequency power supply of said charging base is controlled based on the voltage signal and the current signal detected by the receiver to provide AC power to said energizing coil whereby charging the lithium ion battery.

3. The battery-containing unit and the charging base according to claim 1, wherein the detecting circuit of said battery-containing unit detects the voltage and the temperature of the lithium ion battery to be charged, and the transmitter of said battery-containing unit transmits the voltage signal and a temperature signal detected by the detecting circuit to the charging base, wherein the receiver of said charging base receives the signals transmitted from the transmitter of said battery-containing unit and detects the voltage signal and the temperature signal of the lithium ion battery, and the high frequency power supply of said charging base is controlled based on the voltage signal and the temperature signal detected by the receiver to provide AC power to said energizing coil whereby charging the lithium ion battery.

4. The battery-containing unit and the charging base according to claim 1, wherein said battery-containing unit includes a feedback circuit that controls the high frequency power supply based on the signal detected by said receiver, wherein the high frequency power supply is controlled through the feedback circuit based on the signal detected by said receiver to charge the lithium ion battery.

5. The battery-containing unit and the charging base according to claim 4, wherein said feedback circuit controls the high frequency power supply based on the provided signal to charge the lithium ion battery at a constant voltage and a constant current.

6. The battery-containing unit and the charging base according to claim 4, wherein if the voltage of the lithium ion battery in charging operation becomes higher than a preset value, said feedback circuit controls the high frequency power supply to reduce the output of the high frequency power supply, and if the voltage of the lithium ion battery in the charging operation becomes lower than the preset value, said feedback circuit controls the high frequency power supply to increase the output of the high frequency power supply, so that the charging operation is controlled to bring the voltage of the lithium ion battery to the preset value.

7. The battery-containing unit and the charging base according to claim 2, wherein said battery-containing unit includes a feedback circuit that controls the high frequency power supply based on the signal detected by said receiver, wherein in the operation where the lithium Ion battery is charged at a constant current, if a charging current is smaller than a preset value, the feedback circuit controls the high frequency power supply to increase the output of the high frequency power supply, and if the charging current is greater than the preset value, the feedback circuit controls the high frequency power supply to reduce the charging current, so that the charging current is brought to the preset value.

8. The battery-containing unit and the charging base according to claim 1, wherein the transmitter of said battery-containing unit includes a modulating circuit that modulates carrier waves according to the voltage of the lithium ion battery, and a transmitting antenna that wirelessly transmits a signal modulated by the modulating circuit by radio waves, wherein the receiver of said charging base includes a receiving antenna that receives the radio waves wirelessly transmitted from the transmitter, and a receiving circuit that demodulates the signal received by the receiving antenna to detect the voltage signal.

9. The battery-containing unit and the charging base according to claim 8, wherein said transmitter modulates the carrier waves in the ASK manner according to the signal provided from the detecting circuit, and transmits the modulated signal by radio waves through the transmitting antenna.

10. The battery-containing unit and the charging base according to claim 8, wherein the transmitting antenna of said transmitter is arranged in proximity to the energized coil, and the receiving antenna of said receiver is arranged in proximity to the energizing coil.

11. The battery-containing unit and the charging base according to claim 1, wherein the transmitter of said battery-containing unit transmits the voltage signal of the lithium ion battery to the charging base through the energized coil and the energizing coil.

12. The battery-containing unit and the charging base according to claim 11, wherein the transmitter of said battery-containing unit includes a switching element that controls ON/OFF switching timing based on the voltage signal of the lithium ion battery and is connected to the output side of the energized coil, wherein the load impedance of the energized coil is controlled by the ON/OFF switching of the switching element so that the voltage signal of the lithium ion battery is transmitted to the charging base.

13. The battery-containing unit and the charging base according to claim 12, wherein said transmitter includes a control circuit that controls, based on the voltage signal of the lithium ion battery, a switching-ON period of the switching element.

14. The battery-containing unit and the charging base according to claim 12, wherein said transmitter includes a control circuit that controls, based on the voltage signal of the lithium ion battery, an ON state time width of the switching element.

15. The battery-containing unit and the charging base according to claim 11, wherein said transmitter provides high frequency output to the energized coil through a coupling capacitor.

16. The battery-containing unit and the charging base according to claim 11, wherein said receiver includes a coupling capacitor that provides the receiving circuit with high frequency output produced in the energizing coil.

17. The battery-containing unit and the charging base according to claim 12, wherein said battery-containing unit comprises an impedance element that is serially connected to said switching element, wherein a serial connection circuit of the switching element and the impedance element is connected to the energized coil.

18. The battery-containing unit and the charging base according to claim 17, wherein said impedance element is a capacitor.

19. The battery-containing unit and the charging base according to claim 11, wherein said transmitter includes a modulating circuit that modulates carrier waves according to the voltage of the lithium ion battery, wherein the carrier waves modulated by the modulating circuit is provided to the energized coil, wherein the receiver of said charging base includes a receiving circuit that demodulates the carrier waves transmitted from the energized coil to the energizing coil and detects the voltage signal.

20. The battery-containing unit and the charging base according to claim 1, wherein said battery-containing unit comprises a detachable battery pack, wherein the battery pack includes the lithium ion battery, a shield film that shields the lithium ion battery from an AC magneto field of the energizing coil, the charging circuit for the lithium ion battery, and the transmitter that transmits the voltage signal of the lithium ion battery to the charging base.
